(19) United States
(12) Patent Application Publication
(10) Pub. No.: US 2012/0156455 A1
(43) Pub. Date: Jun. 21, 2012

(54) GAS FILLED INSULATION CONSTRUCTION PANEL

(75) Inventors: Ales Kralj, Ljubljana (SI); Rudi Hajdinjak, Gornja Radgona (SI)

(73) Assignees: REFLEX d.o.o., 9250 Gornja Radgona (SI); CBS INSTITUT CELOVITE GRADBENE RESITVE, d.o.o., Trebnje (SI)

(21) Appl. No.: 13/393,239

(22) PCT Filed: Mar. 29, 2010
(86) PCT No.: PCT/SI2010/000017

§ 371 Date: Feb. 29, 2012

(30) Foreign Application Priority Data
Sep. 8, 2009 (IS) P-200900241

(51) Int. Cl. B32B 7/02; B32B 3/26

(52) U.S. Cl. 428/213; 428/305.5

(57) ABSTRACT

A gas filled panel (GFP) intended for general use, especially in construction, mostly in prefabricated building envelopes, i.e., integrated facades. A panel of the first embodiment is characterized in that it is a two- or more-chamber panel made of at least approximately plan parallel chambers with a mutual distance larger than or equal 8 mm, preferably between 8 and 12 mm, filled with insulation gas, which is a binary or ternary mixture of gases from hydro-fluorocarbons (HFC), carbon dioxide and argon and the mixture has an average molecular mass higher than 50 and lower than 71. A panel of the second embodiment is characterized in that it is a three- or more-chamber panel made of at least approximately plan parallel chambers with a mutual distance larger than or equal 18 mm, preferably between 18 and 22 mm, filled with insulation gas, or a mixture of gases having an average molecular mass higher than 38 and lower than 50.

### CROSS-REFERENCE TO RELATED APPLICATIONS

The present application is a National Stage 371 application of PCT/SI2010/000017, filed on Mar. 29, 2010, which in turn claims priority from Slovenian Patent Application P-200900241 filed on Sep. 8, 2009, both of which are incorporated herein by reference.

### FIELD OF THE INVENTION

The subject of the invention is a gas filled insulation construction panel. The panel of the invention belongs to technical solutions in the field of heat insulation achieved by the principle of a gas filled panel (GFP) intended for general use, especially in construction, mostly in prefabricated building envelopes, i.e., integrated facades.

### BACKGROUND OF THE INVENTION

Thermal insulation of buildings is important in achieving lower energy consumption. An increased need for efficient thermal insulation gave rise to a need for insulation systems having thermal conductivity smaller than that of the air, i.e., 0.024 W/mK. This requirement narrows the possibilities of use of the air as the basis for thermal insulation. The present invention does not touch the area of high insulation materials having thermal conductivity below 0.015 W/mK. Technical problems related thereto are too big to manufacture construction elements for general consumption.

The task of the invention is to fabricate an insulation construction panel having thermal insulation that provides for thermal protection with an effective thermal conductivity lower than that of the air. A further task is that such panel should not transfer more noise through its body, which is very important for the use of such panel in construction.

In construction, it is nowadays attempted to fabricate thermal insulation materials based on nanofoams or aerogels and vacuum panels that have thermal conductivity lower than that of the air. Prior art in the field of aerogels is still burdened by the slowness of the final process of supercritical expansion. Aerogel possess a small capacity of withstanding mechanical loads, which means that their use in construction should be supported by an additional structure. Attainable thermal conductivities of commercial aerogels currently available are between 0.015 and 0.020 W/mK. Nowadays, aerogels are very expensive, as their price reaches at least twenty-times the price of ordinary construction insulation materials. Somewhat more affordable are vacuum panels reaching initial thermal conductivities down to 0.004 W/mK. Vacuum panels are mostly enclosed with thin polymeric aluminized films that are supposed to ensure the permanent nature of the vacuum, which is normally supported by a nanosilica core, i.e., silica fume. However, a solution with aluminized films is not very reliable, since the permanent nature of vacuum within a panel is based on accelerated tests of permeation of gases from the air into the panel, wherein the fact of ageing of the thin aluminum coating is mostly neglected.

Yet neither aerogels nor vacuum panels intrinsically provide a considerable sound insulation and a further solution would be needed to achieve a more considerable sound insulation.

Munters, U.S. Pat. No. 1,969,621, issued Aug. 7, 1934, was the first to suggest a fabrication of general purpose thermal insulation panels based on the GFP principle. His invention suggested a solution with the then-available heavy molecular gases like SF₆CH₃CI, CCI₂F₂, S0₂F₂, CH₃Br, C₂H₅I, SO₂ and CS₂ and the mixtures thereof. A space between chamber partitions for such heavy gases must amount to less than 5 mm to prevent convection. To partition the chambers he suggested a use of aluminum sheets or an alternation of aluminum sheets and paper or simply densely packed sheets of paper.

Kruck et al, U.S. Pat. No. 4,959,111 issued Sep. 25, 1990, suggested insulation based on GFP for the needs of refrigerators. The invention suggested the use of novel heavy gases, namely the refrigerant R12, R12B and CO₂, CBrCIF₂, CF₃I and CBrF₃. The spaces between chambers should be 3 mm to mostly 4 mm to stop convection.

A majority of the above mentioned gases are nowadays not acceptable for use in such insulation panels due to being destructive to the ozone layer of the Earth's atmosphere, due to a high global warming potential (GWP) in combination with photochemical degradation and due to acidity upon degradation in the atmosphere and flammability. The above-mentioned gases, with the exception of CO₂, SO₂, and CS₂, have very low thermal conductivity within a rank of 0.005 W/mK at room temperatures.

Use of gases having such low thermal conductivity is not economical. Merely a transfer of heat through spacing members of a one square meter large GFP panel transfers almost so much heat as is transferred through a static gas. Moreover, gases with such low thermal conductivity have a relatively high density of 5 kg/m3 and more, which entails very narrow gaps between chamber partitions of a GFP panel, which results in high manufacturing costs due to a multitude of needed chambers. Production of such gases is complicated and therefore their price per surface unit is high due to a relatively high density.

Mixtures of gases have been proposed several times for the needs of thermal insulation in general, e.g., in Rotermund et al., U.S. Pat. No. 5,965,231, issued Oct. 12, 1999, McHugh, U.S. Pat. No. 5,792,523, issued Aug. 11, 1998, Graf, Published German Patent Application No. DE 10258377 published Dec. 13, 2002, as well as others. The mixtures described in these patents are either meant for the foaming of polymeric foams or for the production of window GFP panels. The latter would be suited for our purposes if they did not contain krypton in order to reach thermal conductivity of the filling gas below 0.015 W/mK. Krypton is isolated through separation from the air, where it is present in a concentration of approximately 1 ppm. Krypton is not available in quantities large enough and is unaffordable. The field of refrigerant agents or heat transfer fluids is treated in Singh Ravji et al., U.S. Pat. No. 7,238,299, issued Jul. 3, 2007. They suggest using non-azeotropic mixtures of CO₂ and R32 for the transfer of heat. Richard et al., EP Patent No. EP 0576550, published May 22, 1996, suggests preparation of non-flammable binary or ternary non-azeotropic blends of CO₂, R23, and R32 for refrigeration techniques as a substitute for the ozone-destructive R22. Non-flammable R32-based blends are preferred in insulation panels due to their low thermal conductivity of about 0.011 W/mK and low density at normal conditions: 2 kg/m3. Unfortunately, R32 in itself is flammable.

Prior art solutions have gaps between chamber partitions or spacing member heights of approximately 4 mm. Prior art solutions make use of gases having high molecular mass and thermal conductivity of about 0.005 W/mK. Thermal radiation effectively adds 0.0015 W/mK, and spacing members on a one square meter big panel further 0.0035 W/mK or more. Considering the heat transfer through gas, radiation between chambers and heat transfer through spacing members, the prior art solutions have effective thermal conductivity of about 0.01 W/mK. 50 mm of such thermal insulation would be needed in compliance with the currently valid regulations in civil engineering. This represents as many as 12 to 13 chambers of this type. A further problem would be encountered in a gap between the chambers due to contacts between chamber partitions, which are normally made of a metallic foil, since the distance between the foils amounts to approximately 4 mm and the spacing members are arranged even more than 1 m from each other.

### SUMMARY OF THE INVENTION

The panel of the invention is a GFP panel with chambers partitioned with metallic sheets and filled with gases having in the sense of insulation lower thermal conductivity than the air, yet a relatively small density, so that the gap between chamber partitions of a GFP panel may be larger and the number of chambers smaller. Where krypton based mixtures are to be replaced, a mixture of R32 with an addition of R23 was used in order to achieve lower density, lower thermal conductivity and non-flammability, which is a safety prerequisite. Further, optimum configurations of gaps of GFP panels were determined for the needs in construction based on gas filling with argon, carbon dioxide and preferably a mixture of R32 and R23. A pressure problem within the panel caused by an increased temperature is solved by an upper sheet or construction board being concave, which, when temperature is increased, allows expansion or depression without a considerable mechanical load to the structure of the panel.

### BRIEF DESCRIPTION OF THE DRAWINGS

The invention will be described by way of a research, embodiments and the enclosed drawing, in which:

FIG. 1 shows a cross-section of a gas-filled insulation construction panel of the present invention.

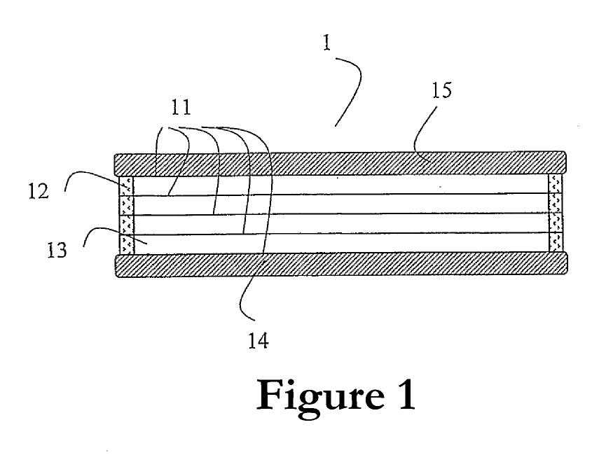

### DETAILED DESCRIPTION OF THE INVENTION

A gas filled insulation construction panel 1 (GFP) of the invention consists of a first construction board 14 and a second construction board 15 with chambers 13 in between, and of partitions between chambers 13 and spacers 12 arranged at least on the outer circumference. The partitions 11 between the chambers 13 should have low thermal emissivity at least on one side. Insulation gases used in the chambers of the invention are selected among those having a mean molecular mass between 38 and 71, in a special case between 50 and 71. Our research has shown that target thermal conductivities of <0.024 W/mK are achieved by using least technical effort if the number of chambers and spacers is kept at the lowest level possible. Owing to a requirement for low thermal conductivity, the spacers are the most complicated component and it is therefore most favorable if their number is kept low.

Our research has shown that the available gases with a molecular mass of up to 71 have, economically speaking, a mass and consequently density barely small enough in normal conditions to have convection limited to the space between the gaps 8 mm and more. Of course, it has been considered that there is more than one chamber and that temperature gets distributed between individual chambers. Gaps of a size of 8 mm and more are still applicable for the manufacture of windows having at least two chambers. An 8 mm gap between chambers is still sufficient to prevent a contact of possible thin metallic films between the spacers. Such selection of a gas contributes to the price efficiency of the gas and to a simplification in the manufacturing of the panel, which can thus have fewer chambers by a half. Thermal conductivity of thermal insulation gases having a molecular mass about 38 is approximately 0.018 W/mK. Gases having an even lower molecular mass have a higher thermal conductivity. At a molecular mass of 29, thermal conductivity reaches approximately that of the air. Our research has shown that thermal conductivity of a gas exceeding 0.018 W/mK results in unpractical thicknesses of insulation required by construction regulations and increases the costs of a product due to a consumption of more material. In short, we found out that insulation gases having a molecular mass of 38 or slightly above are like meant to reach the optimal solution as far as costs are concerned. The costs of material and labor have been taken into consideration. The gases argon and carbon dioxide fall within this range of molecular masses.

More advanced solutions having an even lower thermal conductivity require gasses with an even lower thermal conductivity. Krypton is normally used in Prior Art, however, it is only available in limited quantities due to complicated production and it is not cost-efficient. Our invention suggests using hydrofluorocarbon (HFC), methylenefluoride (R32) having a molecular mass 52 and thermal conductivity between 0.011 and 0.012 W/mK. This gas is available in industrial quantities, has low toxicity, acceptable global warming potential, is not destructive to ozone and is photochemically degradable upon possible leakage into the atmosphere due to the activity of the sun's UV light. Unfortunately, R32 is flammable. This problem is solved by an addition of fluoroform (R23) and carbon dioxide (CO₂). R32 becomes non-flammable if added a volume of 24.7% of R23 or 55.2% of CO₂. The data on needed concentrations were taken from Richard et al., EP Patent No. EP 0576550, published May 22, 1996, as represented in Table 3. Let us stress that such insulation panel can also be fabricated by means of pure R23. Like R32 also R23 photochemically degrades upon possible leakage due to the activity of the UV light.

During a process of filling chambers with gas, up to 7% of air often remains in the chambers, so we hereinafter talk about the chambers, which are predominantly filled with insulation gas.

By using a similarity theory for convection (Nusselt number) we determined the smallest gap between chambers that still impedes a more considerable convection at a temperature difference of 25K. An 8 mm gap between chambers is needed to block convection of gases having higher density from a range of molecular masses between 50 and 71. If there is a multitude of chambers, the temperature difference between the external and the internal side of the panel distributes over individual chambers. As a lower temperature difference in a chamber also decreases convection, the panels provided with a higher number of chambers may have larger gaps between chambers. In case of 5 chambers, the gap may be 10 mm, in case of 6 chambers or more, the gap may not exceed 12 mm. When the gases having a lower molecular mass between 38 and 50 are in question, the gap between chamber partitions can be wider. Our research showed that a thermal insulation structure with an insulation gas having a mass between 38 and 50 and provided with three chambers may have a gap between chambers up to 18 mm. In case of four chambers, this gap may not exceed 20 mm and in case of five chambers, the gap may not exceed 22 mm.

Chambers are separated by a partition, most often an aluminum foil. If used in window panels, the partition is usually a float glass with a low emissivity coating applied on at least one inner side. In order to limit the transfer of heat by radiation to a technically acceptable level, the surface emissivity of the chamber partition should be on one side at least 0.05 or less. In emissivities exceeding 0.05, the contribution of radiation to the effective thermal conductivity of a panel exceeds 0.002 W/mK, which is no longer acceptable, since the loss of thermal insulation would amount to as much as about 10% or more. The emissivity condition is met by all commercially available low-emission coated float glasses, and aluminum sheet as well.

The aluminum or any other metallic sheet of a partition between chambers also serves as a gas barrier. Spacers between chambers arranged on the external circumference of the panel must also be provided with a gas barrier at least in the form of a special membrane. If the spacers are not manufactured of metal, they need to be provided with a metallic membrane at least in height linking the distance between two chamber partitions. The metallic membrane may be a thin band e.g. of a steel or aluminum sheet metal, but can also be a thin layer of a metal applied by a method of vacuum coating. According to Prior Art, satisfactory gas sealing can be achieved by glass and ceramic layers, which are, however, not very suited for the manufacture of spacers that are subject to repeated bending.

Spacers must moreover comply with further limitations concerning a transfer of heat that is allowed to go past a spacer. It is favorable if spacers are made of stainless steel having thermal conductivity below 16 W/mK. Such steel is for instance cold rolled stainless steel 1, 4301. The effective substitute thickness of a spacer linking the gap between two chamber partitions is the thickness of a vertical steel band having thermal conductivity of 16 W/mK, which conducts as much heat as the very spacer. Such definition is used due to a possibility that a metallic membrane could be contoured or even additionally perforated in order to hinder a stream of heat through a spacer. One membrane may only be perforated when there is at least one further parallel membrane, which is not perforated and thus provides for the chamber being gas tight. In the latter case, a spacer may have a form of a tubular structure made of a thin steel sheet. Only one of the vertical membranes may be perforated, i.e., one tube wall, since at least one of them must be gas tight. However, the effective substitute thickness of a spacer does not comprise a transfer of heat through a potential layer of putty applied over spacers along the external circumference of a panel edge. The effective substitute thickness of a spacer comprises a transfer of heat through potential components of a spacer made of non-metallic materials. To ensure that a transfer of heat through a spacer is not too considerable, its effective substitute thickness should not exceed 0.2 mm. If it were greater, a contribution of a spacer to the effective transfer of heat would amount to as much as 0.006 W/mK at a square panel with a side of 1 meter. In comparison with the thermal conductivity of argon for instance, which is 0.018 W/mK, this represents more than a 30% increase to the value, which, together with the contribution of the thermal radiation, already exceeds 0.025 W/mK. And this is more than the target value.

Gas-tight spacers 12 and partition 1 sheets must be joined by a gas-tight adhesive or sealing compound. In window panels, butyl, silicon or polyurethane sealing compounds are usually applied. Yet our research further showed that it is favorable for the bending rigidity of the entire panel, if the binder between the spacers has a structural nature, i.e., hard rubber preventing elastic shifts or slips between the spacers put one above the other. The elastic modulus of the rubber should be at least 4 MPa and the shore A hardness of at least 55. To achieve adequate stiffness, the width of the joint must be at least 6 mm and the height of an individual coating in the final situation should not exceed 0.5 mm. The entire panel may be subsequently coated over the external surface of the spacers with a structural binder, which is normally a polysulfide, silicone or polyurethane rubber in a window system.

When used in construction, the panel should be provided with at least a first construction board 14 intended for protection against external influences. When built into a building, the first construction board faces the exterior of the building. The first construction board must have a bending strength of at least 9 MPa and a thickness of at least 12 mm. Boards of lower strength or smaller thickness do not provide for satisfactory bending resistance to weather conditions in ranks used in construction. If the strength is higher, e.g. in glass or polymeric composites, the board may, exceptionally, be only 8 mm thick. Normally, such panel has another construction board 15 arranged from the inner side and such board may be a plasterboard or cardboard possibly with an added gas-tight barrier.

Our research has proved that partitioning metallic sheets between chambers should be at least 0.01 mm and mostly 0.1 mm thick. Sheets thinner than 0.01 mm are not industrially applicable, wherein the sheets thicker than 0.1 mm are no longer economical. In case of a terminating sheet, i.e. the first and the last sheet in a panel structure, a thicker sheet of 0.02 mm to 0.2 mm must be applied. A terminating sheet thinner than 0.02 mm does not provide for a sufficient mechanical protection of the structure for further manipulation by the method of production and functioning of the panel. Terminating sheets thicker than 0.2 mm are not economical, though. Exceptionally, an insulation panel may be designed in a way that the terminating sheets are simply replaced by a first (14) and a second (15) construction board. In this case, the first and the last chambers are filled with air. Even if the first and the last chambers in the latest case were filled with insulation gases during the manufacturing process, the gases would leak from the first and the last chamber through the construction boards. In this case, the insulation panel has at least two chambers filled with insulation gas and two terminating chambers (the first and the last) filled predominantly with air.

The panel of the invention can be described by the following characteristics.

A gas filled insulation construction panel as a thermal insulation structure comprising hermetically closed chambers filled predominantly with insulation gas, a low-emission substance on at least one side of a partition between chambers, and intermediate spacers is characterized in that it is a two- or more-chamber panel made of at least approximately plan parallel chambers with a mutual distance larger than or equal 8 mm, preferably between 8 and 12 mm, filled with insulation gas, which is a binary or ternary mixture of gases from hydrofluorocarbons (HFC), carbon dioxide and argon and the mixture has an average molecular mass higher than 50 and lower than 71. Chambers are separated by spacers arranged on the external circumference of the panel or inside the panel, wherein the spacers arranged on the external circumference comprise at least a gas-tight membrane over at least 90% of the height of the spacer, preferably over the entire height of the spacer and the spacer between panel chambers is manufactured with a total effective substitute thickness of mostly 0.2 mm, preferably mostly 0.12 mm. Insulation gas in chambers is a binary mixture of 0 vol. %-76 vol. % of methylenefluoride (R32) and 24 vol. %-100 vol. % of fluoroform (R23) or a binary mixture of approximately 75 vol. % of methylenefluoride (R32) and 25 vol. % of fluoroform (R23). The panel may have 2 to 5 chambers with a mutual distance between chambers not exceeding 0 mm and at least one distance between the chambers must amount to 8 mm or more. The panel may also have at least 6 chambers with a mutual distance between chambers not exceeding 12 mm and at least one distance between the chambers must amount to 10 mm or more. Internal chamber partitions are made of a thin aluminum or thin steel stainless sheet of a thickness of 0.01 to 0.1 mm and the terminating external sheets are made of a thin aluminum or thin stainless steel sheet of a thickness of 0.02 to 0.2 mm or the internal chamber partitions can be made of a thin aluminum or thin steel stainless sheet of a thickness of 0.01 to 0.1 mm and the terminating external sheets are replaced by a first and/or second construction board. The joint between the thin metallic sheets and spacers is sealed by a butyl, polyurethane or other gas-tight rubber elastic substance and the stack consists of chambers with spacers placed one above the other and is fastened or coated at the external edge with a polysulfide, silicone, polyurethane or other adequate rubber elastic substance. The first construction board of the panel is fabricated on mineral or polymeric basis and has a thickness of at least 8 mm and bending strength of at least 9 MPa, and the second construction board is preferably fabricated on mineral basis, more preferably a plasterboard.

The panel of the invention of the second embodiment has the following characteristics.

A gas filled insulation construction panel as a thermal insulation structure comprising hermetically closed chambers filled predominantly with insulation gas, a low-emission substance on at least one side of a wall between chambers, and intermediate spacers is characterized in that it is a three- or more-chamber panel made of at least approximately plan parallel chambers with a mutual distance larger than or equal 18 mm, preferably between 18 and 22 mm; filled with insulation gas, or a mixture of gases having an average molecular mass higher than 38 and lower than 50. Chambers are separated by spacers arranged on the external circumference of the panel or inside the panel, wherein the spacers arranged on the external circumference comprise at least a gas-tight membrane over at least 90% of the height of the spacer, preferably over the entire height of the spacer and the spacer between panel chambers is manufactured with a total effective substitute thickness of mostly 0.2 mm, preferably mostly 0.12 mm. Insulation gas or a gas mixture consists mostly of argon, krypton, carbon dioxide or hydrofluorocarbon (HFC). Internal chamber partitions are made of a thin aluminum or thin steel stainless sheet of a thickness of 0.01 to 0.1 mm and the terminating external sheets are made of a thin aluminum or thin stainless steel sheet of a thickness of 0.02 to 0.2 mm or made of a thin aluminum or thin steel stainless sheet of a thickness of 0.01 to 0.1 mm and the terminating external sheets are replaced by a first and/or second construction board. At room temperature conditions at least one sheet is arranged under the second construction board in a concave manner, so that upon an increase in temperature the insulation gas expands towards the internal construction board. Insulation gas of the panel of the invention can be predominantly argon or predominantly carbon dioxide, wherein the panel has 3 chambers with a mutual distance between the chambers of 18 mm or 4 chambers with a mutual distance between the chambers of mostly 20 mm and at least one gap between the chambers is 18 mm or more or has at least 5 chambers with a mutual distance between the chambers of mostly 22 mm and that at least one gap between the chambers is 20 mm or more. The joint between the thin metallic sheets and spacers is sealed by a butyl, polyurethane or other gas-tight rubber elastic substance and the stack consists of chambers with spacers placed one above the other and is fastened or coated at the external edge with a polysulfide, silicone, polyurethane or other adequate rubber elastic substance. The first construction board of the panel is fabricated on mineral or polymeric basis and has a thickness of at least 8 mm and bending strength of at least 9 MPa, and the second construction board is preferably fabricated on mineral basis, more preferably a plasterboard.

### Embodiments

For the first embodiment, samples of a square surface with a side of 150 mm have been prepared. The first and the second construction board were replaced by glass panes from an ordinary float window glass of a thickness of 3 mm. The partitions of four chambers were made of a soft aluminum sheet of the alloy 1050 manufactured by Braun GmbH Folien-Pragetechnik, thickness 0.021 mm. Between the chambers, TGI composite window spacers manufactured by Technoform Glass Insulation GmbH were used, height 12 mm. The joint between spacers and sheets was sealed by butyl rubber GD115, manufactured by Komerling chemische Fabrik GmbH. The sample was filled with a mixture of gases 24.7% R23 and 75.3% R32 (vol.) with thermal conductivity of 0.012 W/mK, supplied by Linde plin d.o.o. At the end, the circumference of the test panel was puttied with polysulfide putty GD1 6 manufactured by Komerling chemische Fabrik GmbH. The sample was measured heat transfer both in vertical and horizontal positions at various temperature differences in order to check the temperature difference, at which a considerable convection of the insulation gas begins. Heat transfer was measured in all samples and embodiments by a factory made up thermal conductivity meter Einplatten-Warmeleitfahigkeitsmessgerat Lambdameter EP500 of the manufacturer Lambda-Messtechnik GmbH. All measurements were performed at a mean temperature of samples of 23° C. Table 1 shows the results of the measurement of the beginning of convection. Theoretical results are indicated based on a similarity theory of heat transfer by convection (Nusselt number).

The value at a temperature difference 0 in the Table was actually measured at a temperature difference of 7.5 K, but in a horizontal position. Theoretical values were additively corrected to match the measured values at a temperature difference of OK. The measured results were also corrected for the effects of heat transfer through two glass panels at the bottom and at the top and for the effects of contact resistance between the panels of the thermal conductivity meter. The results are given in an equivalent of thermal conductivity of an individual chamber bearing in mind the fact that the spacer with the sealing putty also participates in the transfer of heat.

TABLE 1

| Temperature difference | Measured | Theoretical |
|---|---|---|
| per chamber [K] | [W/mK] | [W/mK] |
| 0 | 0.0690 | 0.069 |
| 2.5 | 0.0693 | 0.069 |
| 5 | 0.0703 | 0.070 |
| 7.5 | 0.0715 | 0.072 |
| 10 | 0.0716 | 0.075 |
| 12.5 | 0.0728 | 0.078 |

Our goal was to obtain only a negligible contribution of convection to heat transfer up to a temperature difference of 25K on the entire panel with 7 chambers filled with the gas mixture of R32 and R23. At a temperature difference of 3.6K, which represents one seventh of 25K, it was desired to have a technical situation with little convection. Thermal conductivity of gas and heat transfer with radiation contribute approximately 0.013 W/mK to the results in the Table. The remaining contribution is attributed to the edge and the spacer. At a temperature difference of 2.5K, the increase in heat transfer due to convection is 0.0013 W/mK. This represents a 10% increase in the effective transfer of heat due to gas convection. We find this still acceptable.

The second embodiment included samples of a square surface with a side of 150 mm. A first and a second construction board were replaced by glass panes and ordinary float window glass of a thickness of 4 mm. The underlying glass had a low-emissivity coating as is a standard use in windows. The glasses were kept apart by a steel window spacer Nirotec 017 manufactured by HELIMA Lingemann-Gruppe Helmunt Lingemann GmbH & Co. KG, of a height of 20 mm. The joint between the spacer and glasses was sealed by butyl rubber GD115 manufactured by Komerling chemische Fabrik GmbH. The sample was filled by a mixture of gases 24.7% R23 and 75.3% R32 (vol.) with thermal conductivity of 0.012 W/mK, supplied by Linde plin d.o.o. At the end, the circumference of the test panel was puttied with polysulfide putty GD116 manufactured by Komerling chemische Fabrik GmbH.

The samples thus prepared were loaded by a dose of 500 MJ of ultraviolet light (UV). Such dose corresponds to an exposure of windows in a period of 4 years in a moderate geographical zone in a vertical position. We had to test resistance of the gas mixture to UV radiation that penetrates through a 4 mm float glass and a possible interaction of the gas mixture with the low emissivity coating. UV load entered from the upper float glass devoid of a low emissivity coating. During the load, the sample was at a temperature of 45° C., all polymeric surfaces were protected against direct UV illumination with an aluminum sheet.

After the loading, some increase in thermal conductivity of the test sample was observed. This increase could not be explained satisfactorily only by comparing thermal conductivity, since the sample with the tested gas mixture had some more butyl filler filled towards the inside. There was a possibility that the vapors from butyl would somewhat contaminate the low emissivity coating on the glass. The compared samples were therefore tested against a complete spectrum of optical characteristics of glass, because a potential degradation of the low emissivity coating would be noticed in the form of light scattering or in a change in optical values. The measurements of optical values, however, showed perfect characteristic values.

The third embodiment included samples of a square surface with a side of 500 mm. A first and a second construction boards were replaced by glass panes and ordinary float window glass of a thickness of 3 mm. Two chambers were partitioned by soft aluminum sheets of the alloy 1050 manufactured by Braun GmbH Folien-Pragetechnik of a thickness of 0.025 mm. TGI composite window spacers manufactured by Technoform Glass Insulation GmbH, height 20 mm, were used between chambers. The joint between the spacers and sheets was sealed by butyl rubber GD115 manufactured by Komerling chemische Fabrik GmbH. The sample was filled with commercial argon of a grade of 5.0 with thermal conductivity of 0.018 W/mK. At the end, the circumference of the test panel was puttied with polysulfide putty GD1 6 of the manufacturer Komerling chemische Fabrik GmbH. The sample was measured thermal conductivity in horizontal position in order to establish the contribution of heat radiation between the chambers to the transfer of heat though gas. Combined thermal conductivity of heat transfer through gas and heat radiation was measured to be 0.019 W/mK. As the heat transfer meter has a square measuring zone of 150×150 mm in the center, a sample of 500×500 mm could avoid the transfer of heat through the edge and spacers. Since thermal conductivity of argon at 23° C. amounts to approximately 0.018 W/mK, it can be estimated that the contribution of heat transfer with radiation is approximately 0.001 W/mK.

1. A gas filled insulation construction panel as a thermal insulation structure comprising hermetically closed chambers filled predominantly with insulation gas, a low-emission substance on at least one side of a partition between chambers, and intermediate spacers characterized in that it is a two- or more-chamber panel made of at least approximately plan parallel chambers with a mutual distance larger than or equal 8 mm, preferably between 8 and 12 mm, filled with insulation gas, which is a binary or ternary mixture of gases from hydrofluorocarbons (HFC), carbon dioxide and argon and the mixture has an average molecular mass higher than 50 and lower than 71.

2. Panel as claimed in claim 1, characterized in that chambers are separated by spacers arranged on the external circumference of the panel or inside the panel, wherein the spacers arranged on the external circumference comprise at least a gas-tight membrane over at least 90% of the height of the spacer, preferably over the entire height of the spacer and the spacer between panel chambers is manufactured with a total effective substitute thickness of mostly 0.2 mm, preferably mostly 0.12 mm.

3. Panel as claimed in claim 1 or 2, characterized in that insulation gas in chambers is a binary mixture of 0 vol. %-76 vol. % of methylenefluoride (R32) and 24 vol. %-100 vol. % of fluoroform (R23).

4. Panel as claimed in claim 3, characterized in that insulation gas in chambers is a binary mixture of approximately 75 vol. % of methylenefluoride (R32) and 25 vol. % of fluoroform (R23).

5. Panel as claimed in claims 1 to 4, characterized in that said panel has 2 to 5 chambers with a mutual distance between chambers not exceeding 10 mm and at least one distance between the chambers must amount to 8 mm or more.

6. Panel as claimed in claims 1 to 4, characterized in that said panel has at least 6 chambers with a mutual distance between chambers not exceeding 12 mm and at least one distance between the chambers must amount to 10 mm or more.

7. Panel as claimed in claims 1 to 6, characterized in that said internal chamber partitions are made of a thin aluminium or thin steel stainless sheet of a thickness of 0.01 to 0.1 mm and the terminating external sheets are made of a thin aluminium or thin stainless steel sheet of a thickness of 0.02 to 0.2 mm.

8. Panel as claimed in claims 1 to 6, characterized in that said internal chamber partitions are made of a thin aluminium or thin steel stainless sheet of a thickness of 0.01 to 0.1 mm and the terminating external sheets are replaced by a first and/or second construction board.

9. Panel as claimed in claim 7, characterized in that a joint between the thin metallic sheets and spacers is sealed by a butyl, polyurethane or other gas-tight rubber elastic substance and the stack consists of chambers with spacers placed one above the other and is fastened or coated at the external edge with a polysulfide, silicone, polyurethane or other adequate rubber elastic substance.

10. Panel as claimed in claim 8, characterized in that a first construction board of the panel is fabricated on mineral or polymeric basis and has a thickness of at least 8 mm and bending strength of at least 9 MPa.

11. Panel as claimed in claim 10, characterized in that it has apart from the first construction board on one side a second construction board on the other side, which is preferably fabricated on mineral basis, more preferably a plasterboard.

12. A gas filled insulation construction panel as a thermal insulation structure comprising hermetically closed chambers filled predominantly with insulation gas, a low-emission substance on at least one side of a partition between chambers, and intermediate spacers characterized in that it is a three- or more-chamber panel made of at least approximately plan parallel chambers with a mutual distance larger than or equal 18 mm, preferably between 18 and 22 mm, filled with insulation gas, or a mixture of gases having an average molecular mass higher than 38 and lower than 50.

13. Panel as claimed in claim 12, characterized in that chambers are separated by spacers arranged on the external circumference of the panel or inside the panel, wherein the spacers arranged on the external circumference comprise at least a gas-tight membrane over at least 90% of the height of the spacer, preferably over the entire height of the spacer and the spacer between panel chambers is manufactured with a total effective substitute thickness of mostly 0.2 mm, preferably mostly 0.12 mm.

14. Panel as claimed in claim 12 or 13, characterized in that insulation gas or a gas mixture consists mostly of argon, krypton, carbon dioxide or hydrofluorocarbon (HFC).

15. Panel as claimed in claims 12 to 14, characterized in that said internal chamber partitions are made of a thin aluminium or thin steel stainless sheet of a thickness of 0.01 to 0.1 mm and the terminating external sheets are made of a thin aluminium or thin stainless steel sheet of a thickness of 0.02 to 0.2 mm.

16. Panel as claimed in claims 12 to 14, characterized in that said internal chamber partitions are made of a thin aluminium or thin steel stainless sheet of a thickness of 0.01 to 0.1 mm and the terminating external sheets are replaced by a first and/or second construction board.

17. Panel as claimed in claim 15 or 16, characterized in that at room temperature conditions at least one sheet is arranged under the first construction board in a concave manner, so that upon an increase in temperature the insulation gas expands towards the internal construction board.

18. Panel as claimed in claims 12 to 17, characterized in that insulation gas is predominantly argon or predominantly carbon dioxide, and that said panel has 3 chambers with a mutual distance between the chambers of 18 mm.

19. Panel as claimed in claims 12 to 17, characterized in that insulation gas is predominantly argon or predominantly carbon dioxide, and that said panel has 4 chambers with a mutual distance between the chambers of mostly 20 mm and at least one gap between the chambers is 18 mm or more.

20. Panel as claimed in claims 12 to 17, characterized in that insulation gas is predominantly argon or predominantly carbon dioxide, and that said panel has at least 5 chambers with a mutual distance between the chambers of mostly 22 mm and that at least one gap between the chambers is 20 mm or more.

21. Panel as claimed in claim 15 or 16, characterized in that a joint between the thin metallic sheets and spacers is sealed by a butyl, polyurethane or other gas-tight rubber elastic substance and the stack consists of chambers with spacers placed one above the other and is fastened or coated at the external edge with a polysulfide, silicone, polyurethane or other adequate rubber elastic substance.

22. Panel as claimed in claims 1 to 21, characterized in that a first construction board of the panel is fabricated on mineral or polymeric basis and has a thickness of at least 8 mm and bending strength of at least 9 MPa.

23. Panel as claimed in claim 22, characterized in that it has apart from the first construction board on one side a second construction board on the other side, which is preferably fabricated on mineral basis, more preferably a plasterboard.
